(19) United States
(12) Patent Application Publication
(10) Pub. No.: US 2026/0189752 A1
(43) Pub. Date: Jul. 2, 2026

(54) IMAGE QUALITY ENHANCING DEVICE AND IMAGE QUALITY ENHANCING METHOD

(71) Applicant: MEDIATEK INC., Hsinchu City (TW)

(72) Inventors: Ming-En Shih, Hsinchu City (TW); Chung-Yi Chen, Hsinchu City (TW); Yu-Cheng Tseng, Hsinchu City (TW); Kuo-Chen Huang, Hsinchu City (TW)

(73) Assignee: MEDIATEK INC., Hsinchu City (TW)

(21) Appl. No.: 19/006,150

(22) Filed: Dec. 30, 2024

(51) Int. Cl. H04N 7/015; G06F 3/14; G06T 5/60

(52) U.S. Cl. CPC H04N 21/4402; G06T 5/60; H04N 21/4126; G06F 3/14

(57) ABSTRACT

An image quality enhancing device for a display device is disclosed. The image quality enhancing device includes a mobile chip and a video processing module. The mobile chip has a modem module and a signal receiving module. The signal receiving module is adapted to receive an incoming video stream from an external signal source. The video processing module is communicated with the mobile chip. The video processing module is adapted to perform an image enhancing task on the incoming video stream for generating an enhanced video stream and further to output the enhanced video stream to a display panel of the display device.

### BACKGROUND

With the advanced technology, a demand for the high-quality display device that provide a superior viewing experience is ever-growing, particularly with the rise of streaming media and online video content. However, the conventional display device cannot provide the high-level image quality that users desire because a processing chip of the conventional display device cannot smoothly process the fast-paced or the high-resolution content. Therefore, design of a solution that integrates the mobile chip within the display device for elevating the viewing experience is a possible issue in the display industry.

### SUMMARY

The present invention provides an image quality enhancing device and an image quality enhancing method of using a mobile chip to enhance image quality of an incoming video stream for a large display device for solving above drawbacks.

According to the claimed invention, an image quality enhancing device for a display device is disclosed. The image quality enhancing device includes a mobile chip and a video processing module. The mobile chip has a modem module and a signal receiving module. The signal receiving module is adapted to receive an incoming video stream from an external signal source. The video processing module is communicated with the mobile chip. The video processing module is adapted to perform an image enhancing task on the incoming video stream for generating an enhanced video stream and further to output the enhanced video stream to a display panel of the display device.

According to the claimed invention, the modem module is applied to at least one of 4th generation mobile networks, 5th generation mobile networks and 6th generation mobile networks, and the mobile chip utilizes the signal receiving module other than the modem module to receive the incoming video stream.

According to the claimed invention, the image quality enhancing device and a display chip of the display device are mounted on the same circuit board to form a multi-chip system, or the image quality enhancing device and the display chip are packaged together to form a multi-chip package. The image quality enhancing device and the display chip are connected via heterogeneous integration technology, so as to form a chiplet package and integrate inside the same case of the display device. The image quality enhancing device and the display chip are integrated via wafer stacking technology to form a three-dimensional integrated circuit package. The image quality enhancing device has a video performing module adapted to replace a video performing function of a display chip of the display device, and the image quality enhancing device is installed inside the display device to directly drive the display device to display the enhanced video stream.

According to the claimed invention, the video processing module is adapted to execute a real-time image detail generation or recovery function for the incoming video stream with a resolution higher than standard definition and at 24 frames per second. The video processing module includes an image processing unit adapted to perform various image enhancing tasks that contain noise reduction, color correction and contrast enhancement on the incoming video stream for increasing image quality of the enhanced video stream. The image processing unit is adapted to utilize generative artificial intelligence to perform a real-time image detail generation or recovery function on the incoming video stream so as to optimize the image enhancing task.

According to the claimed invention, the video processing module includes a display processing unit adapted to process the enhanced video stream and output the enhanced video stream to the display device for ensuring correct display with minimal latency. The display device with the large size standard is indicated as the display device of 24 inches or more than 24 inches.

According to the claimed invention, an image quality enhancing method is applied to an image quality enhancing device for a display device. The image quality enhancing method includes a signal receiving module of the image quality enhancing device receiving an incoming video stream from an external signal source, a video processing module of the image quality enhancing device performing an image enhancing task on the incoming video stream for generating an enhanced video stream, and the video processing module outputting the enhanced video stream to a display panel of the display device.

The image quality enhancing device and the image quality enhancing method of the present invention can utilize computing power and ability of supporting the artificial intelligence algorithm of the specific-designed mobile chip to increase the image quality of the display device; the display device can be selected from a group consisting of a television, a monitor and a projector. The image quality enhancing device can utilize high computational power of the video processing module and the generative artificial intelligence used in the image processing unit to perform and optimize the image enhancing task on the incoming video stream for generation of the enhanced video stream, and the display processing unit can process the enhanced video stream to ensure the correct display with minimal latency and then transmit the enhanced video stream towards the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image quality enhancing device according an embodiment of the present invention.

FIG. 2 to FIG. 4 are application diagrams of the image quality enhancing device matched with a display device according to different embodiments of the present invention.

FIG. 5 is a flow chart of an image quality enhancing method according to the embodiment of the present invention.

### DETAILED DESCRIPTION

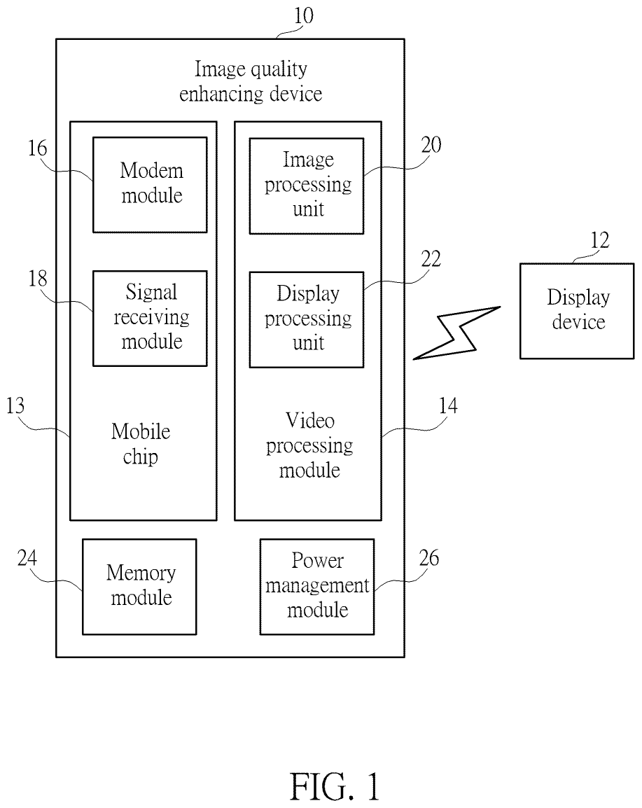

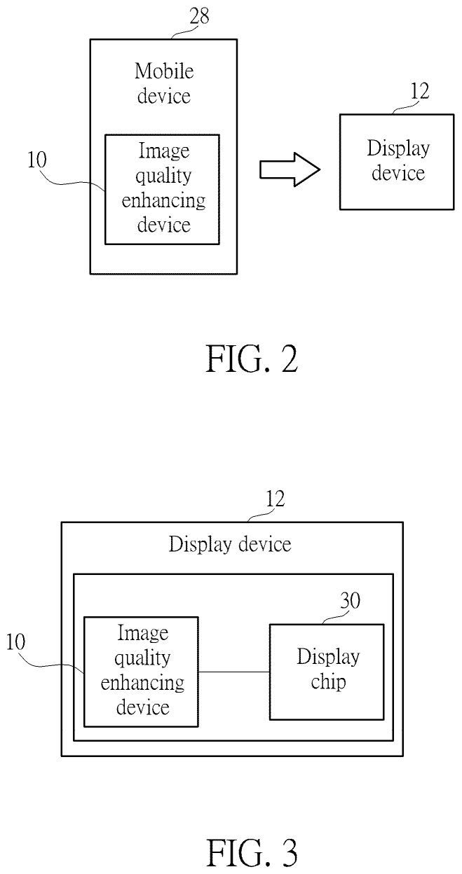

Please refer to FIG. 1 to FIG. 4. FIG. 1 is a functional block diagram of an image quality enhancing device 10 according an embodiment of the present invention. FIG. 2 to FIG. 4 are application diagrams of the image quality enhancing device 10 matched with a display device 12 according to different embodiments of the present invention. The image quality enhancing device 10 can be a mobile chip 13 and a video processing module 14 integrated with each other. The mobile chip 13 can be the chip of a smartphone or a tablet computer, and the mobile chip 13 can include a modem module 16 and a signal receiving module 18. The modem module 16 can be applied to at least one of 4th generation mobile networks, 5th generation mobile networks and 6th generation mobile networks. The image quality enhancing device 10 can utilize the signal receiving module 18 to receive an incoming video stream from an external signal source, such as the streaming service or other video sources. It should be mentioned that the image quality enhancing device 10 cam utilize the signal receiving module 18 other than the modem module 16 to receive the incoming video stream.

The image quality enhancing device 10 can further utilize the video processing module 14 to perform one or plural image enhancing tasks on the incoming video stream for generating an enhanced video stream, and transmit the enhanced video stream towards the display device 12. The video processing module 14 can at least include an image processing unit 20 and a display processing unit 22. The image processing unit 20 can perform the image enhancing tasks, such as noise reduction, color correction and/or contrast enhancement, on the incoming video stream received by the signal receiving module 18, so as to upgrade or increase image quality of the enhanced video stream. A type of the image enhancing task is not limited to the foresaid embodiment, and depends on an actual demand. Besides, the image processing unit 20 can optionally utilize generative artificial intelligence (GAI) to perform a real-time image detail generation or recovery function on the incoming video stream (or the related enhanced video stream) with a resolution higher than standard definition (SD) and at 24 frames per second (FPS), so as to optimize the image enhancing task, and further to ensure that the image quality enhancing device 10 can generate the enhanced video stream with minimal power consumption and computational resource.

The display processing unit 22 can process the enhanced video stream and then transmit the enhanced video stream towards the display device 12, and therefore can ensure that the enhanced video stream is displayed by the display device 12 correctly with minimal latency. Generally, the display processing unit 22 can utilize any appropriate transmission interface, such as the mobile industry processor interface (MIPI), the display port (DP), the embedded display port (eDP), the high definition multimedia interface (HDMI), the low-voltage differential signaling (LVDS) and the wireless fidelity (Wi-Fi), to transmit the enhanced video stream towards the display device 12, specially suitable for the display device 12 with a large size standard of 24 inches or more than 24 inches; practical application of the transmission interface and a size of the display device 12 are not limited to the foresaid embodiments.

In addition, the image quality enhancing device 10 can further include a memory module 24 and a power management module 26. The memory module 24 can be any of the dynamic random access memory (DRAM), the static random access memory (SRAM), the read only memory (ROM); an element with a data storage function can conform to a design demand of the memory module 24 in the present invention. The memory module 24 can store the enhanced video stream and relevant date. The memory module 24 can be selected based on its capacity, speed and power consumption, in accordance with an actual demand of the image quality enhancing device 10, and a detailed description is omitted herein for simplicity. The power management module 26 can ensure that the image quality enhancing device 10 is powered efficiently so that power consumption can be minimized to a lowest possible level.

As shown in FIG. 2, the image quality enhancing device 10 can be installed on the mobile device 28 (such as the smartphone or the tablet computer); the user can operate the mobile device 28 to activate an image quality enhancing function of the image quality enhancing device 10, and the mobile device 28 can transmit the enhanced video stream generated by the image quality enhancing function towards the display device 12 in a wired manner or in a wireless manner. That is to say, in the embodiment shown in FIG. 2, the mobile device 28 can be the smartphone or the tablet computer that includes the image quality enhancing device 10 and in independent from the display device 12; practical application of the mobile device 28 is not limited to the foresaid embodiment.

As shown in FIG. 3, the image quality enhancing device 10 and a display chip 30 of the display device 12 can be mounted on the same circuit board to form a multi-chip system, or the image quality enhancing device 10 and the display chip 30 can be packaged together to form a multi-chip package; in this embodiment, the mobile chip (which is integrated with the video processing module 14 to form the image quality enhancing device 10) originally used in the smartphone or the tablet computer can be installed inside the display device 12 together with the display chip 30, and therefore the display device 12 can have the related image quality enhancing function due to the built-in image quality enhancing device 10 with the display chip 30.

In this embodiment, the image quality enhancing device 10 and the display chip 30 can be connected with each other via heterogeneous integration technology, so as to form a chiplet package and integrate inside the same package case; moreover, the image quality enhancing device 10 and the display chip 30 may be integrated with each other via wafer stacking technology to form a three-dimensional integrated circuit package (3D IC package); that is to say, the image quality enhancing device 10 and the display chip 30 are integrated into the same product and installed in the case of the display device 12.

As shown in FIG. 4, the present invention can dispose a video performing module 32 into the image quality enhancing device 10, and the image quality enhancing device 10 can be installed in the display device 12; the video performing module 32 can be used to provide and replace a video performing function of the display chip of the display device 12. Therefore, the display device 12 can remove its display chip in this embodiment, and the image quality enhancing device 10 having the video performing module 32 can be installed inside the display device 12 and directly perform the image quality enhancing function and then display the enhanced video stream on the display panel of the display device 12. The image quality enhancing device 10 having the video performing module 32 can replace the display chip of the display device 12 and be a processing chip of the display device 12.

Comparing the above-mentioned embodiments, the embodiment shown in FIG. 2 can install the image quality enhancing device 10 into the mobile device 28, and the mobile device 28 can generate and transmit the enhanced video stream towards the display device 12 in a remote control manner; the embodiment shown in FIG. 3 can manufacture a combination or integration of the image quality enhancing device 10 and the display chip 30 as the same product, and install the foresaid product into the display device 12; the embodiment shown in FIG. 4 can replace the original display chip of the display device 12 by the image quality enhancing device 10 having the video performing module 32.

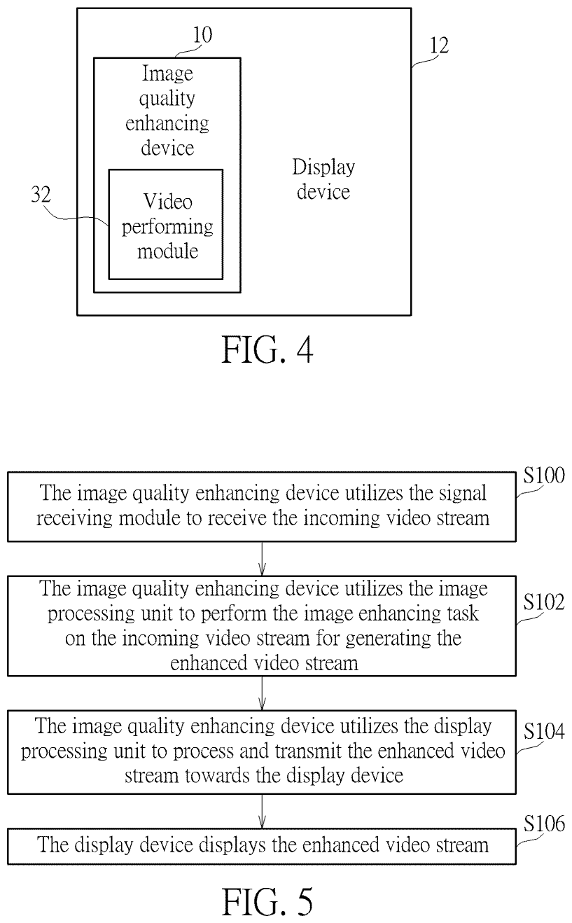

Please refer to FIG. 5. FIG. 5 is a flow chart of an image quality enhancing method according to the embodiment of the present invention. The image quality enhancing method illustrated in FIG. 5 can be suitable for the image quality enhancing device 10 shown in FIG. 1 to FIG. 4. First, step S100 can be executed that the image quality enhancing device 10 utilizes the signal receiving module 18 to receive the incoming video stream from the external signal source. Then, step S102 can be executed to utilize the image processing unit 20 of the video processing module 14 to perform the image enhancing task on the incoming video stream for generating the enhanced video stream; in step S102, the image processing unit 20 may use the generative artificial intelligence (GAI) to perform the real-time image detail generation or recovery function on the incoming video stream with the resolution higher than the standard definition and at 24 frames per second, so as to optimize the image enhancing task for the display device 12. Later, step S104 can be executed to utilize the display processing unit 22 of the video processing module 14 to process the enhanced video stream and then transmit the enhanced video stream towards the display device 12 through the transmission interface. Final, step S106 can be executed to display the enhanced video stream on the display device 12.

In conclusion, the image quality enhancing device and the image quality enhancing method of the present invention can utilize computing power and ability of supporting the artificial intelligence algorithm of the specific-designed mobile chip to increase the image quality of the display device; the display device can be selected from a group consisting of a television, a monitor and a projector. The image quality enhancing device can utilize high computational power of the video processing module and the generative artificial intelligence used in the image processing unit to perform and optimize the image enhancing task on the incoming video stream for generation of the enhanced video stream, and the display processing unit can process the enhanced video stream to ensure the correct display with minimal latency and then transmit the enhanced video stream towards the display device.

In the present invention, a mobile chip can be used as a component of the image quality enhancing device of executing the image quality enhancing method within an ecosystem of the display device. The image quality enhancing device and the image quality enhancing method of the present invention can perform the real-time image detail generation or recovery function on the incoming video stream (for example, with the resolution higher than the standard definition and at 24 frames per second), so that the image quality enhancing device of the present invention can be seamlessly integrated into a large display device, so as to offer a cost-effective solution for increasing or upgrading the image quality with the minimal power consumption and computational resource.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image quality enhancing device for a display device, the image quality enhancing device comprising:
a mobile chip having a modem module and a signal receiving module, the signal receiving module being adapted to receive an incoming video stream from an external signal source,
a video processing module being adapted to perform an image enhancing task on the incoming video stream for generating an enhanced video stream and further to output the enhanced video stream to a display panel of the display device.

2. The image quality enhancing device of claim 1, wherein the modem module is applied to at least one of 4th generation mobile networks, 5th generation mobile networks and 6th generation mobile networks, and the mobile chip utilizes the signal receiving module other than the modem module to receive the incoming video stream.

3. The image quality enhancing device of claim 1, wherein the image quality enhancing device and a display chip of the display device are mounted on the same circuit board to form a multi-chip system, or the image quality enhancing device and the display chip are packaged together to form a multi-chip package.

4. The image quality enhancing device of claim 1, wherein the image quality enhancing device and a display chip of the display device are connected via heterogeneous integration technology, so as to form a chiplet package and integrate inside the same case of the display device.

5. The image quality enhancing device of claim 4, wherein the image quality enhancing device and a display chip of the display device are integrated via wafer stacking technology to form a three-dimensional integrated circuit package.

6. The image quality enhancing device of claim 1, wherein the image quality enhancing device comprises a video performing module adapted to replace a video performing function of a display chip of the display device, and the image quality enhancing device is installed inside the display device to directly drive the display device to display the enhanced video stream.

7. The image quality enhancing device of claim 1, wherein the video processing module is adapted to execute a real-time image detail generation or recovery function for the incoming video stream with a resolution higher than standard definition (SD) and at 24 frames per second (FPS).

8. The image quality enhancing device of claim 1, wherein the video processing module comprises an image processing unit adapted to perform various image enhancing tasks that contain noise reduction, color correction and contrast enhancement on the incoming video stream for increasing image quality of the enhanced video stream.

9. The image quality enhancing device of claim 8, wherein the image processing unit is adapted to utilize generative artificial intelligence (GAI) to perform a real-time image detail generation or recovery function on the incoming video stream so as to optimize the image enhancing task.

10. The image quality enhancing device of claim 1, wherein the video processing module comprises a display processing unit adapted to process the enhanced video stream and output the enhanced video stream to the display device for ensuring correct display with minimal latency.

11. The image quality enhancing device of claim 1, wherein the display device with the large size standard is indicated as the display device of 24 inches or more than 24 inches.

12. An image quality enhancing method applied to an image quality enhancing device for a display device, the image quality enhancing method comprising:
a signal receiving module of the image quality enhancing device receiving an incoming video stream from an external signal source;
a video processing module of the image quality enhancing device performing an image enhancing task on the incoming video stream for generating an enhanced video stream; and
the video processing module outputting the enhanced video stream to a display panel of the display device.

13. The image quality enhancing method of claim 12, wherein the image quality enhancing device further comprises a modem module, the modem module is applied to at least one of 4th generation mobile networks, 5th generation mobile networks and 6th generation mobile networks, and the image quality enhancing device utilizes the signal receiving module other than the modem module to receive the incoming video stream.

14. The image quality enhancing method of claim 12, wherein the image quality enhancing device and a display chip of the display device are mounted on the same circuit board to form a multi-chip system, or the image quality enhancing device and the display chip are packaged together to form a multi-chip package.

15. The image quality enhancing method of claim 12, further comprising:
utilizing heterogeneous integration technology to connect the image quality enhancing device with a display chip of the display device are connected for forming a chiplet package integrated inside the same case of the display device.

16. The image quality enhancing method of claim 12, further comprising:
utilizing wafer stacking technology to integrate the image quality enhancing device with a display chip of the display device for forming a three-dimensional integrated circuit package.

17. The image quality enhancing method of claim 12, wherein the image quality enhancing device further has a video performing module adapted to replace a video performing function of a display chip of the display device, and the image quality enhancing device is installed inside the display device to directly drive the display device to display the enhanced video stream.

18. The image quality enhancing method of claim 12, further comprising:
the image quality enhancing device executing a real-time image detail generation or recovery function for the incoming video stream with a resolution higher than standard definition (SD) and at 24 frames per second (FPS).

19. The image quality enhancing method of claim 11, further comprising:
an image processing unit of the video processing module performing various image enhancing tasks that contain noise reduction, color correction and contrast enhancement on the incoming video stream for increasing image quality of the enhanced video stream.

20. The image quality enhancing method of claim 19, further comprising:
the video processing module utilizing generative artificial intelligence (GAI) to perform a real-time image detail generation or recovery function on the incoming video stream so as to optimize the image enhancing task.

21. The image quality enhancing method of claim 12, further comprising:
a display processing unit of the video processing module processing the enhanced video stream and outputting the enhanced video stream to the display device for ensuring correct display with minimal latency.

22. The image quality enhancing method of claim 12, wherein the display device with the large size standard is indicated as the display device of 24 inches or more than 24 inches.
